(19) United States
(12) Patent Application Publication
(10) Pub. No.: US 2007/0223530 A1
(43) Pub. Date: Sep. 27, 2007

(54) Method and apparatus for managing network configuration, and computer product

(75) Inventors: Kuniaki Shimada, Kawasaki (JP); Yukihiro Watanabe, Kawasaki (JP); Keiichi Oguro, Kawasaki (JP); Ken Yokoyama, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/454,850

(22) Filed: Jun. 19, 2006

(30) Foreign Application Priority Data
Mar. 24, 2006 (JP) 2006-083942

(51) Int. Cl. H04J 3/16

(52) U.S. Cl. 370/469

(57) ABSTRACT

A network-configuration management apparatus manages a configuration of a network in which a plurality of network devices including a plurality of servers is connected. An upper-layer-specification receiving unit receives an upper layer specification from a user. A grouping unit groups the servers based on the received upper layer specification. A configuration display unit that displays the configuration of the network based on the grouping of the servers.

### BACKGROUND OF THE INVENTION

1. Field of the Invention

The present invention relates to a technology for managing a configuration of a network in which a plurality of network devices is connected.

2. Description of the Related Art

There are conventional network configuration management devices (such as the one disclosed in Japanese Patent Laid-Open Publication No. 2005-348051) that manage physical connections between network devices (such as routers, servers, switches, etc.) that form a network configuration, determining which cable connects which ports of two switches, and displaying the network configuration and the operation status in the form of a network map on a display device such as a monitor.

The conventional network configuration management devices are inadequate when it comes to displaying large-scale networks, as the network devices forming the network configuration will clutter the screen, resulting in lack of clarity of network devices in the periphery of display area of the of the screen.

To overcome the crowding problem, a technology was developed by which a network configuration can be broken up into parts and which allows each part to be viewed in detail.

Layout methods such as tree layout method or dynamic orientation layout method are used for displaying the devices on each of the divided screens.

However, the network map output by the network configuration management device based on the topology data obtained from the network devices and connection calculation is not usually clear enough to meet the administrator's expectations.

When the network map is broken down into several parts, corresponding to a subnet, the size of the each network map depends on the size of the subnet.

To be able to actually manage and operate the network configuration, the administrator has to break down the network map output by the network configuration management device into management units and edit the layout for clarity.

### SUMMARY OF THE INVENTION

It is an object of the present invention to at least partially solve the problems in the conventional technology.

A computer-readable recording medium according to one aspect of the present invention stores therein a computer program for managing a configuration of a network in which a plurality of network devices including a plurality of servers is connected. The computer program causes a computer to execute receiving an upper layer specification from a user; grouping the servers based on the received upper layer specification; and displaying the configuration of the network based on the grouping of the servers.

A method according to another aspect of the present invention is for managing a configuration of a network in which a plurality of network devices including a plurality of servers is connected. The method includes receiving an upper layer specification from a user; grouping the servers based on the received upper layer specification; and displaying the configuration of the network based on the grouping of the servers.

A network-configuration management apparatus according to still another aspect of the present invention manages a configuration of a network in which a plurality of network devices including a plurality of servers is connected. The network-configuration management apparatus includes an upper-layer-specification receiving unit that receives an upper layer specification from a user; a grouping unit that groups the servers based on the received upper layer specification; and a configuration display unit that displays the configuration of the network based on the grouping of the servers.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1A is a drawing of a conventional physical map;

FIG. 1B is a drawing of a physical map output by a network-configuration management apparatus according to an embodiment of the present invention;

FIG. 2 is a functional block diagram of the network-configuration management apparatus according to the present embodiment;

FIG. 3 is a drawing of an example of topology data stored in a topology-data storing unit;

FIG. 4 is a drawing of a network corresponding to the topology data shown in FIG. 3;

FIG. 5 is a functional block diagram of a layout determining unit;

FIG. 6 is a drawing of a directed graph corresponding to the network shown in FIG. 4;

FIG. 7 is a drawing of a process procedure of grouping carried out by a grouping unit based on VLAN data;

FIG. 8 is a drawing of a map displayed by grouping based on the VLAN;

FIG. 9 is a drawing of a process procedure of grouping carried by the grouping unit based on subnet data;

FIG. 10 is a drawing of a map displayed by grouping based on the subnet;

FIG. 11 is a drawing of a process procedure of grouping carried out by the grouping unit based on routing data;

FIG. 12 is a drawing of a map displayed by grouping based on a router group;

FIG. 13 is a drawing of a grouping result based on the topology data shown in FIG. 3;

FIG. 14 is a drawing of a map in which all the groupings, namely, the grouping based on the VLAN data, the subnet data, and the routing data, are shown;

FIG. 15 is a drawing of an X coordinate determination method in which a general tree layout method is used;

FIG. 16 is a drawing of a Y coordinate determination method in which the general tree layout method is used; and

FIG. 17 is a function al block diagram of a computer that executes a network-configuration management program according to the present embodiment.

### DETAILED DESCRIPTION OF THE PREFERRED EMBODIMENTS

Exemplary embodiments of the present invention are explained in detail below with referent to the accompanying drawings.

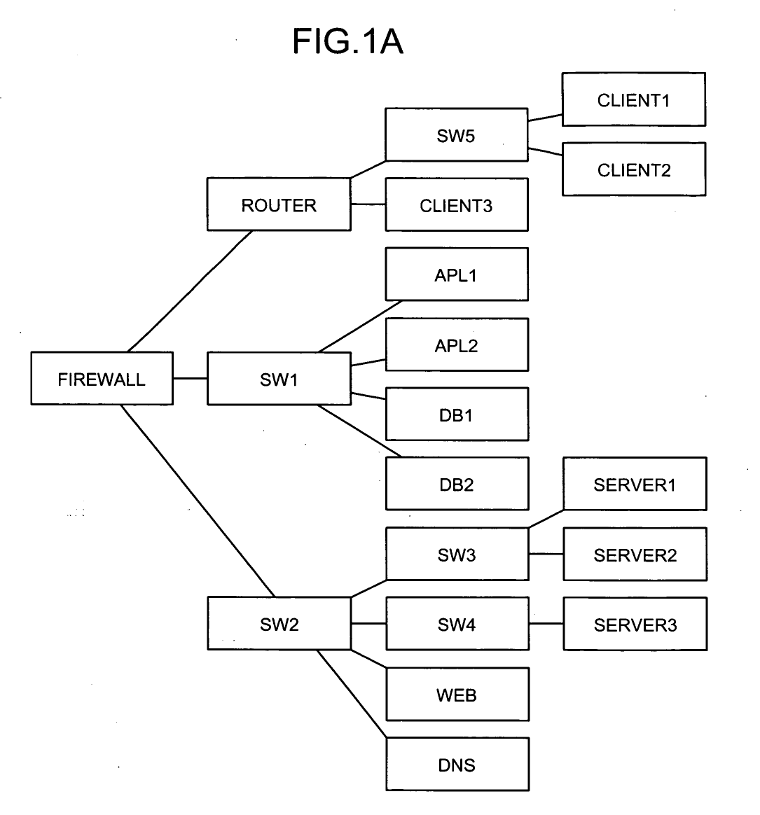

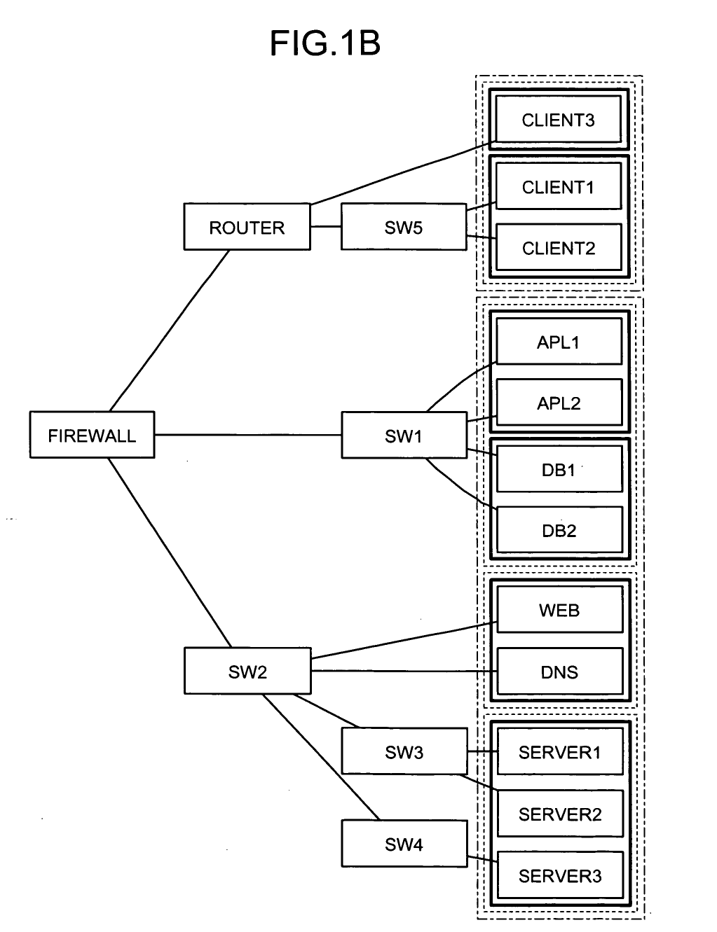

FIG. 1A is a drawing of a conventional physical map. FIG. 1B is a drawing of the physical map output by the network-configuration management apparatus according to an embodiment of the present invention.

In the conventional physical map shown in FIG. 1A, a relation of connections of network devices is represented based on physical-connection data and not by grouping into servers. The term server is a generic term and includes computers that function as clients, represented by client1, client2, and client3, computers that run applications, represented by apl1 and apl2, database servers, represented by db1 and db2, a web server, represented by web, a DNS server, represented by dns, and other computers, represented by server1, server2, and server3.

On the other hand, in the physical map output by the network-configuration management apparatus according to the present embodiment shown in FIG. 1B, the servers are grouped according to data pertaining to an upper layer such as virtual local-area-network (VLAN), subnet, routing, etc.

Thus, the network-configuration management apparatus according to the present embodiment groups the servers based on the upper-layer data, and by placing the servers belonging to one group close to each other produces a clear physical map that a network administrator can easily read.

In the example presented here, the network devices are grouped based on the data pertaining to all the three upper layers, namely, the VLAN, the subnet, and the routing. However, the network-configuration management apparatus according to the present invention allows the network administrator to specify any number of the upper layers, and displays the physical map by grouping the network devices based on the data pertaining to the specified upper layer. This feature gives the network administrator the freedom to specify the upper layers according to the physical map that he/she wants displayed.

In the present example, a solid line or a dotted line frame encloses each group. However, according to user specification, the physical map can be displayed as a layout of the network devices without enclosing the groups in frames. Further, all groups, irrespective of the data pertaining to the upper layer, can be specified by the user to be enclosed by the same kind of frame.

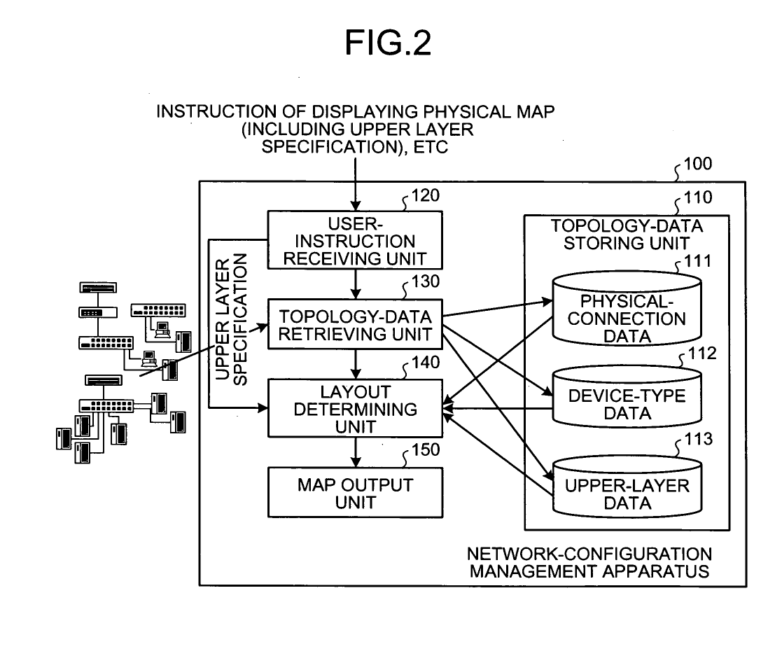

FIG. 2 is a functional block diagram of a network-configuration management apparatus 100 according to the present embodiment. The network-configuration management apparatus 100 includes a topology-data storing unit 110, a user-instruction receiving unit 120, a topology-data retrieving unit 130, a layout determining unit 140, and a map output unit 150.

The topology-data storing unit 110 stores therein network topology data created based on data retrieved from each of the network devices by the topology-data retrieving unit 130. The topology data includes physical-connection data 111 that pertains to the physical connection of the network devices, device-type data 112 that pertains to the type of the network device, and upper-layer data 113, which is data pertaining to the upper layer.

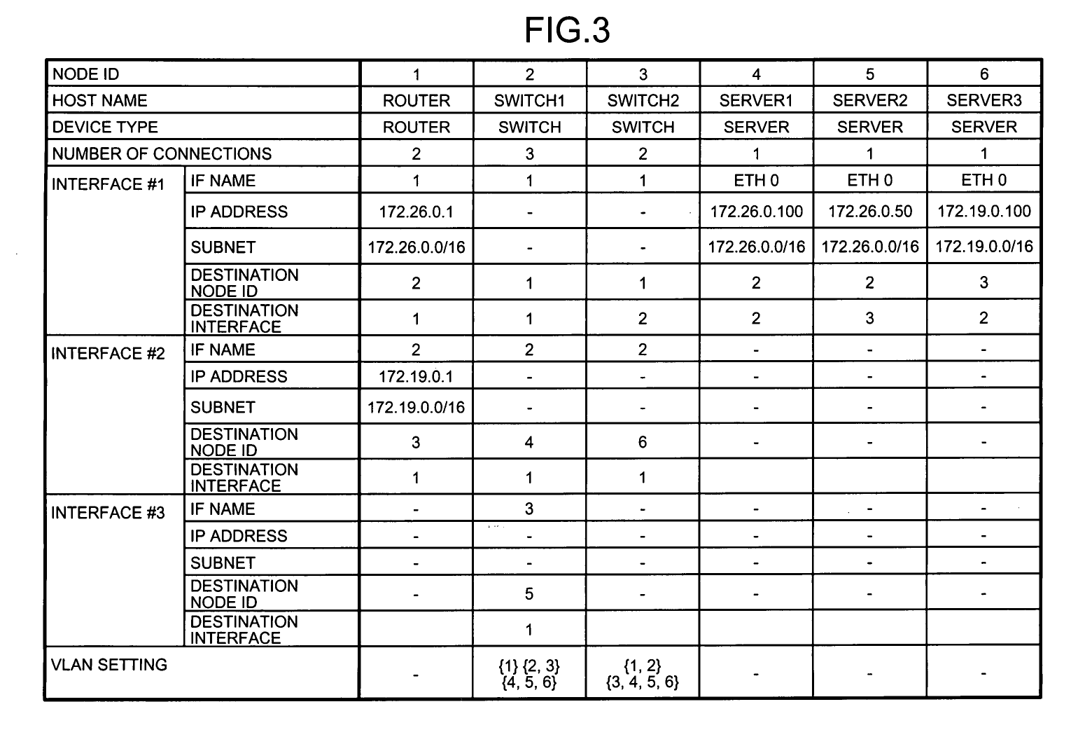

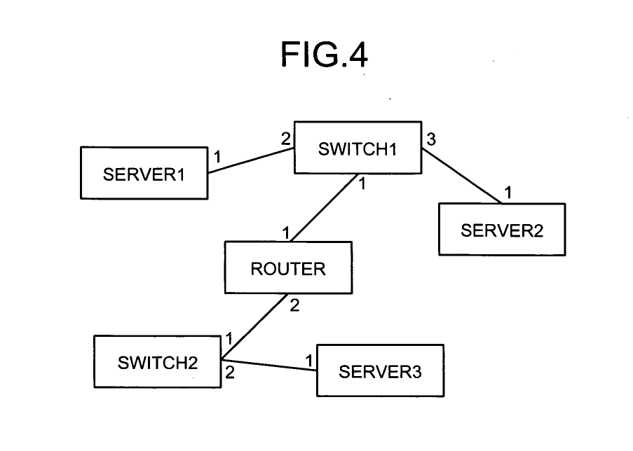

FIG. 3 is a drawing of an example of the topology data stored in the topology-data storing unit 110. FIG. 4 is a drawing of a network corresponding to the topology data shown in FIG. 3. The topology data, as shown in FIG. 3 and FIG. 4, includes data pertaining to the server1, the server2, and the server3, a switch1 and a switch2, and a router. The data of each node (network device) includes Node ID that is a unique ID assigned to the node, host name, device type which is the same as the device-type data 112, number of connections, data related to interface, and VLAN setting which is data related to VLAN setting.

The data related to the interface includes IF name, which is the name of the interface, IP address, subnet, destination Node ID, which is the node ID of the destination node, and destination interface, which is the destination interface ID.

The data related to VLAN setting refers to data pertaining to the interface of switches assigned to each VLAN. For example, Interface #1 of switch1 is assigned to one VLAN, Interface #2 and Interface #3 are assigned to another VLAN, and Interface #4, Interface #5, and Interface #6 are assigned to yet another VLAN. Interface #4, Interface #5, and Interface #6 are not shown FIG. 3 and FIG. 4.

The destination Node ID and destination interface are examples of the physical-connection data 111. The VLAN setting is an example of the upper-layer data 113.

The user-instruction receiving unit 120 receives instructions from the user, such as the network administrator. One of the instructions the user-instruction receiving unit 120 receives from the user is a Display physical map instruction. When receiving the Display physical map instruction, the user-instruction receiving unit 120 receives the specification of the upper layer to be used for grouping the servers.

When receiving the Display physical map instruction, the user-instruction receiving unit 120 receives the specification of the upper layer to be used for grouping the servers and forwards the same to the layout determining unit 140, thereby enabling the network-configuration management apparatus 100 to display the physical map by grouping the network devices based on the data pertaining to the upper layer.

The topology-data retrieving unit 130 retrieves the data pertaining to the topology by using simple network management protocol (SNMP), etc., from the network devices, creates the physical-connection data 111 and the device-type data 112, etc., and stores them as topology data in the topology-data storing unit 110.

The layout determining unit 140 groups the servers based on the upper layer specification made by the user to the user-instruction receiving unit 120, and determines the layout of the network devices in the physical map based on the grouping.

The ability of the layout determining unit 140 to group the servers based on the upper layer specified by the user and determine the layout of the network devices in the physical map based on the grouping results in a clear physical map that can be easily read by the user. The layout determining unit 140 is described in detail in a later section.

The map output unit 150 displays on the display device the physical map based on the layout determined by the layout determining unit 140.

Thus, the network-configuration management apparatus 100 displays the physical map by following the process procedure described below. The user-instruction receiving unit 120 receives the Display physical map instruction from the user, the topology-data retrieving unit 130 retrieves the data pertaining to the topology from all the network devices, the layout determining unit 140 groups the servers and determines the layout based on the data pertaining to the upper layer, and the map output unit 150 outputs the map on the display device.

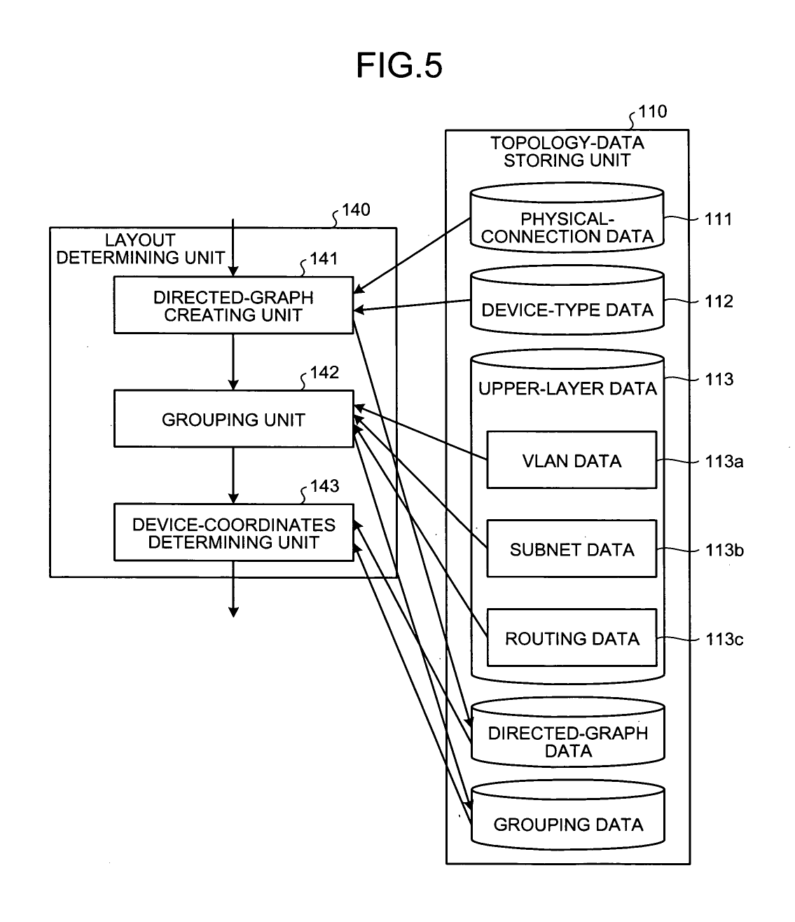

FIG. 5 is a block diagram of the layout determining unit 140. The layout determining unit 140 includes a directed-graph creating unit 141, a grouping unit 142, and a device-coordinates determining unit 143.

The directed-graph creating unit 141 defines the direction for all the connections between the network devices based on the device-type data 112 stored in the topology-data storing unit 110. For example, in the network shown in FIG. 4 that includes servers, switches and a router as device types, the directed-graph creating unit 141 defines the direction in the priority order of router-switch-server, that is, from high priority to low priority.

In other words, the directed-graph creating unit 141 identifies the connections based on the interface data, namely, the destination Node ID/destination interface, of the respective devices using the topology data shown in FIG. 3. For example, the device with the host name server3 has one interface, a destination Node ID of,3 and a destination interface of 2. This indicates that Interface #1 of the server3 and Interface #2 of the switch2 having the Node ID 3 are connected. In this connection, the device type of the server3 is server and that of the switch2 is switch. The directed-graph creating unit 141 compares the two device types, namely the server and the switch, and determines that the switch is of a higher priority. Thus, the directed-graph creating unit 141 defines the direction of the connection from the switch2 to the server3.

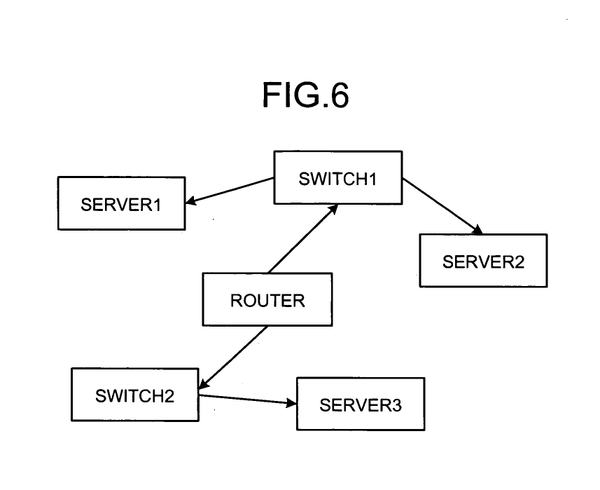

The directed-graph creating unit 141 determines the direction for the other connections as well and creates a directed graph shown in FIG. 6 for the network shown in FIG. 4, and creates a directed-graph data corresponding to the directed graph.

The grouping unit 142 groups the network devices whose device type is server, and creates a grouping data representing the grouping. The grouping unit 142 creates the grouping data based on the upper-layer data 113, namely VLAN data 113a, subnet data 113b, and routing data 113c. The process of the grouping unit 142 is described in detail in a later section.

The device-coordinates determining unit 143 determines the coordinates of the network devices on the physical map based on the directed graph map created by the directed-graph creating unit 141 and the grouping data created by the grouping unit 142. The device-coordinates determining unit 143 is also described in detail in a later section.

Thus, the layout determining unit 140 determines the layout by creates the directed-graph data by following the process procedure described below. The directed-graph creating unit 141 creates the directed-graph data, the grouping unit 142 the grouping data pertaining to the grouping of the network devices whose device type is server and creates the grouping data, and the device-coordinates determining unit 143 determines the coordinates of the network devices on the physical map based on the directed-graph data and the grouping data.

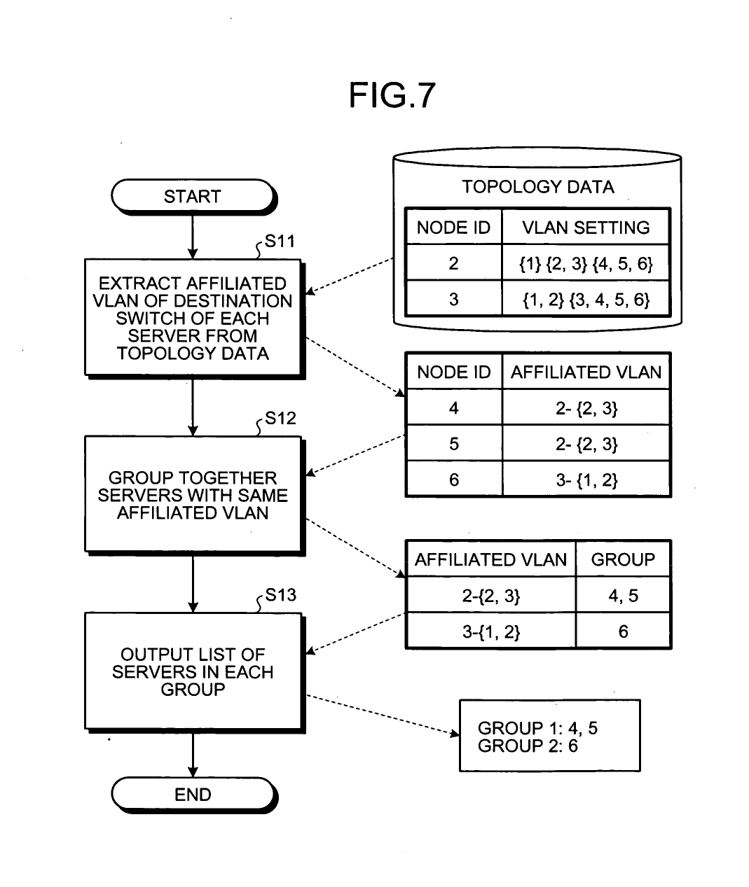

FIG. 7 is a drawing of a process procedure of grouping carried out by the grouping unit 142 based on the VLAN data 113a.

For grouping based on the VLAN data 113a, the grouping unit 142 extracts the affiliated VLAN of the destination switch of each server from the topology data (step S11).

For example, referring to the topology data shown in FIG. 3, it can be discerned, from the VLAN setting of the switches having the Node ID 2 and 3 and the data pertaining to which server is connected to which switch, that the affiliated VLAN of the server whose Node ID is 4 is 2-{2,3}, that of the server whose Node ID is 5 is 2-{2,3}, and that of the server whose Node ID is 6 is 3-{1,2}. 2-{2,3} denotes a VLAN formed by Interface #2 and Interface #3 of the switch having the Node ID 2.

The grouping unit 142 groups servers having the same affiliated VLAN (step S12). In the example shown in FIG. 7, the servers having the Node ID 4 and 5 have the same affiliated VLAN and are therefore are grouped together whereas the server having the Node ID 6 is treated as belonging to a different group.

The grouping unit 142 then outputs the list of servers in each group in the form of the grouping data (step S13). The device-coordinates determining unit 143 determines the coordinates of the network devices on the physical map based on the grouping data output by the grouping unit 142.

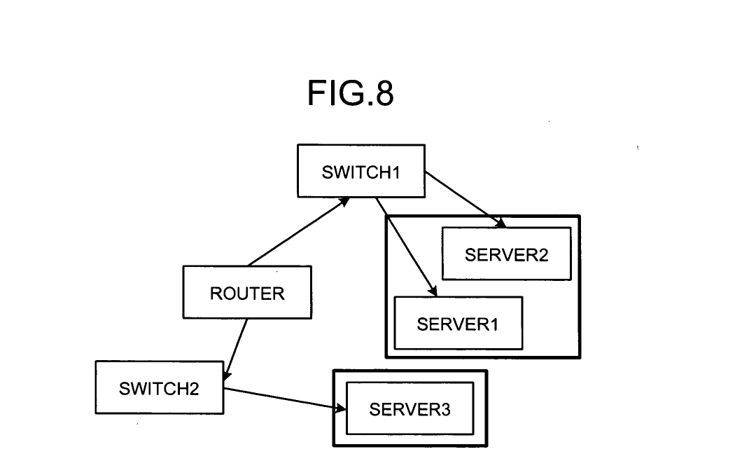

Thus, the grouping unit 142 groups the servers based on the VLAN data 113a, and the device-coordinates determining unit 143 determines the coordinates of the network devices based on the grouping. As a result, a clear physical map is displayed that can be easily read by the network administrator. FIG. 8 is a drawing of a map displayed by grouping based on the VLAN.

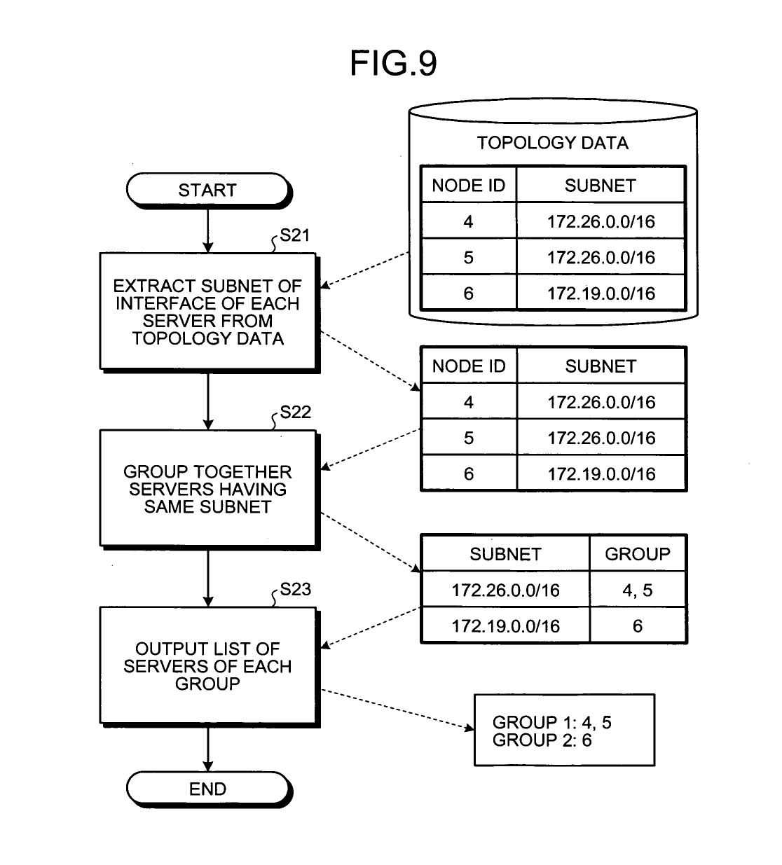

FIG. 9 is a drawing of a process procedure of grouping carried out by the grouping unit 142 based on the subnet data 113b. For grouping based on the subnet data 113b, the grouping unit 142 extracts the subnet of the interface of each server from the topology data (step S21).

For example, from the topology data shown in FIG. 3, the grouping unit 142 extracts 172.26.0.0/16 as the subnet of the server having the Node ID 4, 172.26.0.0/16 as the subnet of the server having the Node ID 5, and 172.19.0.0/16 as the subnet of the server having the Node ID 6.

The grouping unit 142 groups together the servers having the same subnet (step S22). In the example shown in FIG. 9, the servers having the Node ID 4 and 5 have the same subnet and hence are grouped together, whereas the server having the Node ID 6 is treated as belonging to a different group.

The grouping unit 142 then outputs the list of servers in each grouping the form of the grouping data (step S23). The device-coordinates determining unit 143 determines the coordinates of the network devices on the physical map based on the grouping data output by the grouping unit 142.

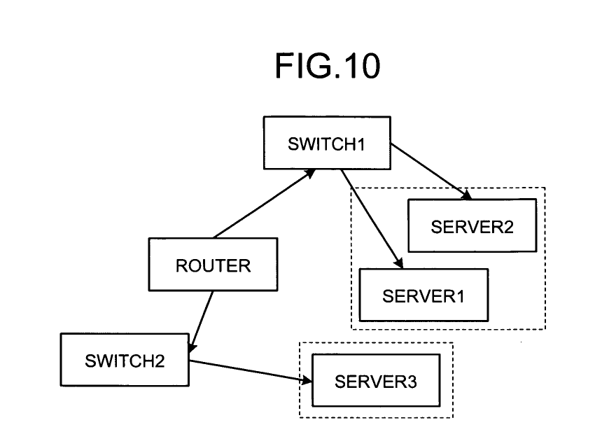

Thus, the grouping unit 142 groups the servers based on the subnet data 113b, and the device-coordinates determining unit 143 determines the coordinates of the network devices based on the grouping. As a result, a clear physical map is displayed that can be easily read by the network administrator. FIG. 10 is a drawing of a map displayed by grouping based on the subnet.

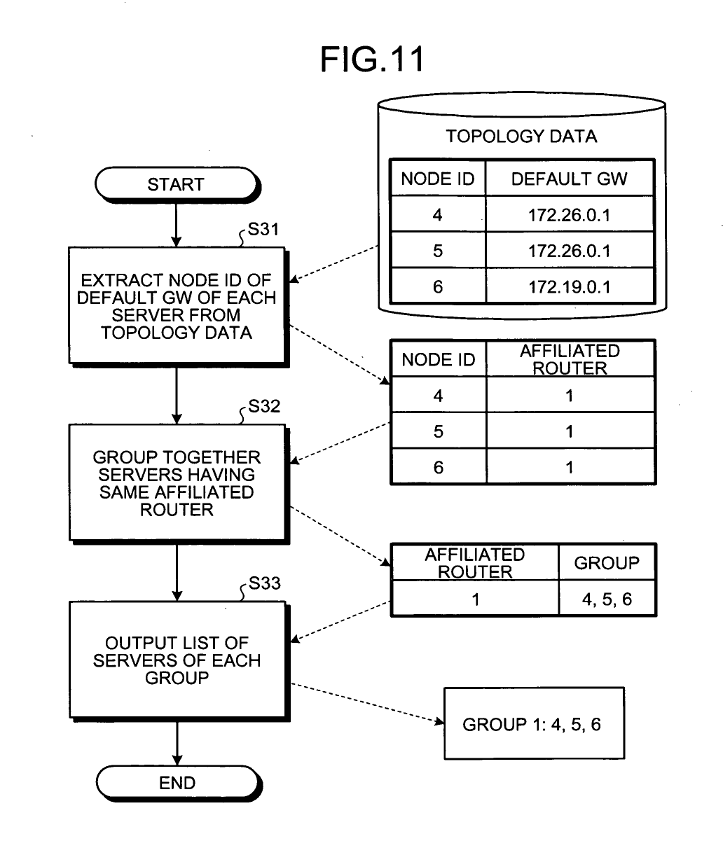

FIG. 11 is a drawing of a process procedure of grouping carried out by the grouping unit 142 based on the routing data 113c. For grouping based on the routing data 113c, the grouping unit 142 extracts the Node ID of the default gateway (default GW) of each server from the topology data (step S31).

For example, from the topology data shown in FIG. 3, it can be discerned that the subnet of the server having the Node ID 4 is 172.26.0.0/16 and that the default GW of the subnet is 172.26.0.1. The grouping unit 142 extracts the Node ID 1 as the affiliated router using the default GW as the Internet Protocol (IP) address. By the same logic, for the servers having the Node ID 5 and 6, the grouping unit 142 again extracts Node ID 1 as the affiliated router.

The grouping unit 142 groups together the servers having the same affiliated router (step S32). In the example shown in FIG. 11, all the three servers with the Node ID 4, 5, and 6 have the same affiliated server and are consequently grouped together.

The grouping unit 142 then outputs the list of servers in each group in the form of the grouping data (step S33). The device-coordinates determining unit 143 determines the coordinates of the network devices on the physical map based on the grouping data output by the grouping unit 142.

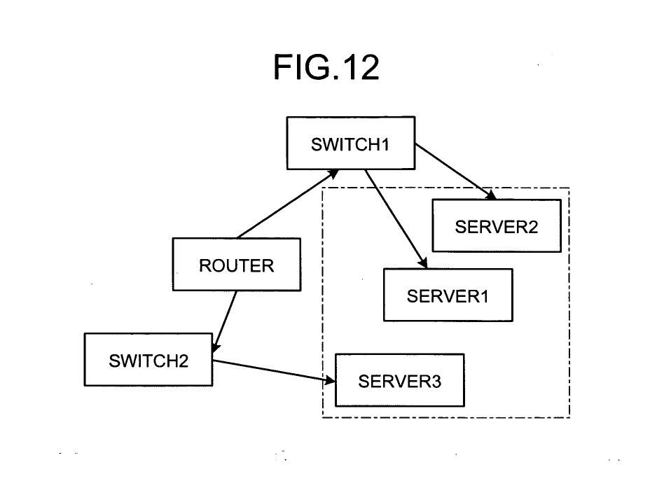

Thus, the grouping unit 142 groups the servers based on the routing data 113c, and the device-coordinates determining unit 143 determines the coordinates of the network devices based on the grouping. As a result, a clear physical map is displayed that can be easily read by the network administrator. FIG. 12 is a drawing of a map displayed by grouping based on a router group.

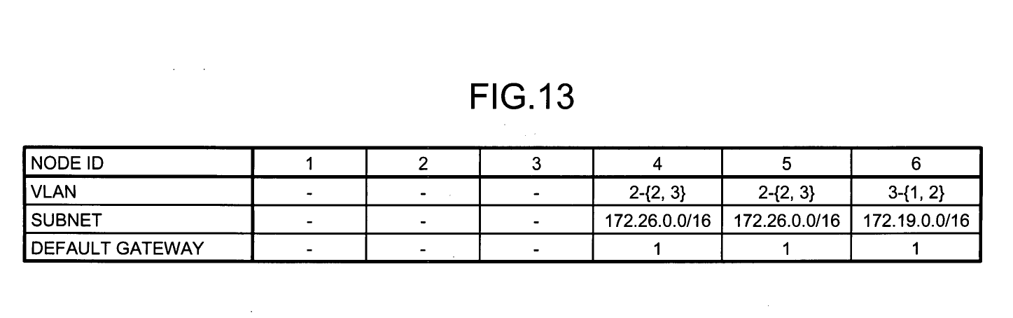

FIG. 13 is a drawing of a grouping result based on the topology data shown in FIG. 3. The grouping result based on the default gateway denotes the grouping result based on the routing data 113c.

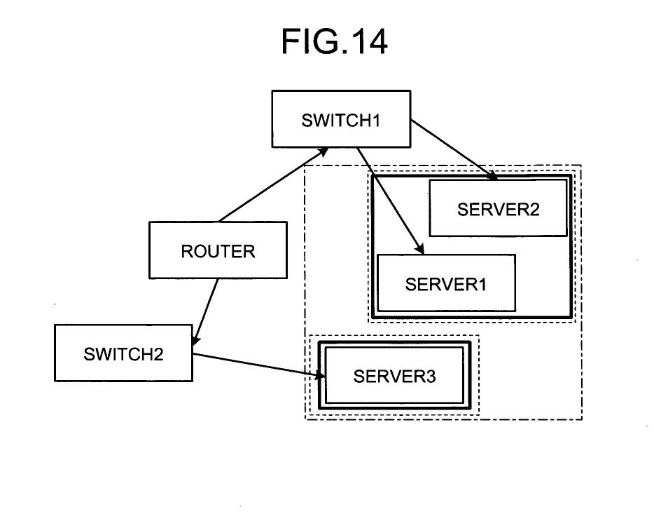

FIG. 14 is a drawing of a map in which all the groupings, namely, the grouping based on the VLAN data 113a, the subnet data 113b, and the routing data 113c, are shown. In this example, the same grouping result is obtained by grouping based on the VLAN data 113a and the subnet data 113b.

The device-coordinates determining unit 143 determines the position of each network device based on the directed-graph data and the grouping data. The directed graph in this case becomes a composite graph and a device coordinates determining method commonly used for composite graphs become applicable.

For example, the device-coordinates determining unit 143 can determine the X coordinate, sequential Y coordinates, and Y coordinate by applying the method described in the paper titled “Visualization of Structural Information: Automatic Drawing of Compound Digraphs” by Sugiyama K. and K. Misue, IEEE Transactions on Systems, Man, and Cybernetics, SMC-21-4, 876/892 1991.

As the example shown in FIG. 14 is that of a general tree, a general tree layout method described in the paper titled “A node-positioning algorithm for general trees” by J. Q. Walker, Software: Practice and Experience, v. 20, n. 7, p. 685-705, July 1990, can be used for determining the device coordinates.

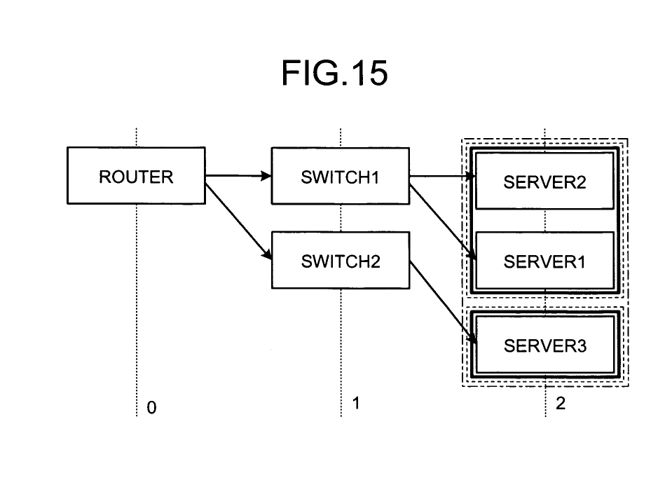

FIG. 15 is a drawing of an X coordinate determination method in which a general tree layout method is used. If the directed graph is in the form of a general tree, the X coordinates can be determined sequentially from the upper layer of the general tree.

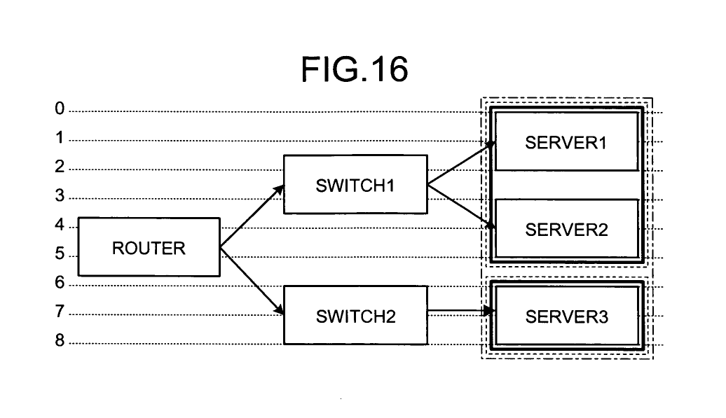

FIG. 16 is a drawing of a Y coordinate determination method in which the general tree layout method is used. If the directed graph is in the form of a general tree, the Y coordinates can be determined based on the maximum value of the number of network devices in each layer of the general tree.

If the network includes router, switches, and servers, as shown in the example in FIG. 14, the X coordinates can be determined by placing the router, switches, and servers sequentially beginning from the left.

Thus, in the present embodiment, the user-instruction receiving unit 120 receives the Display physical map instruction as well as the upper layer specification from the user, the layout determining unit 140 groups the servers based on the upper layer specification received by the user-instruction receiving unit 120, and determines the layout of the network devices based on the grouping result. As a result, a clear physical map that can be easily read by the user is displayed based on the instruction given by the user.

According to the present embodiment, the network-configuration management apparatus is explained. However, a software in the form of a network-configuration management program can implement the function of the network-configuration management apparatus. A computer that executes the network-configuration management program is described next.

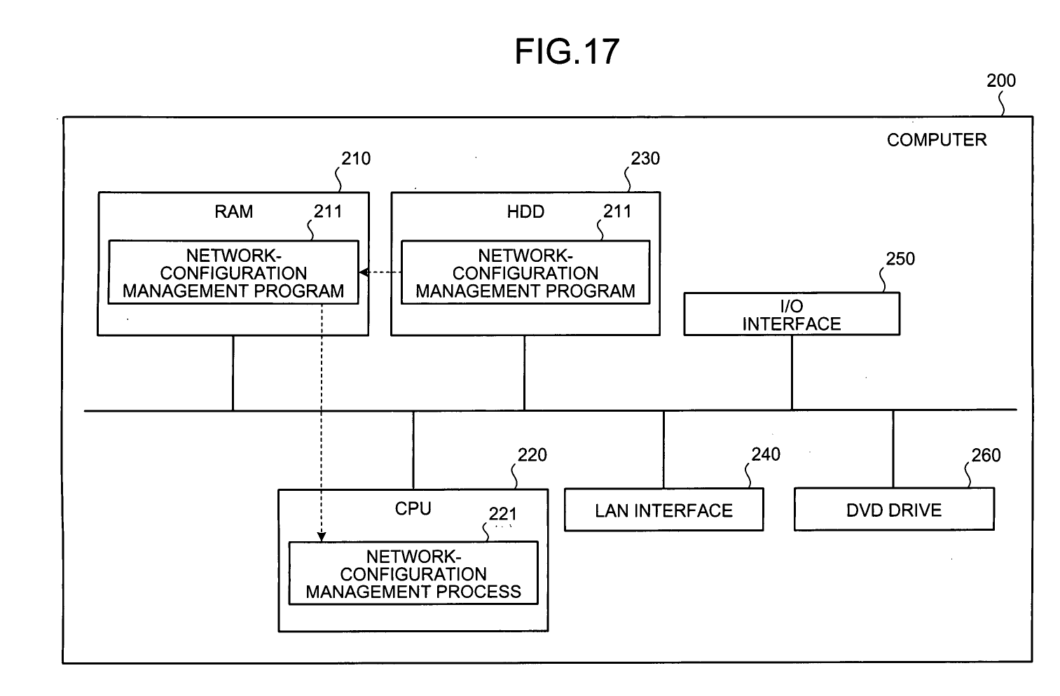

FIG. 17 is a functional block diagram of a computer 200 that executes the network-configuration management program according to the present embodiment. The computer 200 includes a random access memory (RAM) 210, a central processing unit (CPU) 220, a hard disk drive (HDD) 230, a local area network (LAN) interface 240, an input/output (I/O) interface 250, and a digital versatile disk (DVD) drive 260.

The RAM 210 stores therein the program and the calculation results of the program when the program is being executed. The CPU 220 reads the program from the RAM 210 and execute the program.

The HDD 230 stores the program and various data. The LAN interface 240 connects the computer 200 to other computers over a LAN.

The I/O interface 250 connects the computer 200 to an input device such as a mouse, keyboard, etc. as well as to an display device. The DVD drive 260 reads data from and writes data to a DVD.

A network-configuration management program 211 executed by the computer 200 is stored in a DVD and is read from the DVD by the DVD drive 260 and installed on the computer 200.

Alternatively, the network-configuration management program 211 may be stored in a database of another computer connected to the computer 200 via the LAN interface 240, and can be read from the database and installed on the computer 200.

The network-configuration management program 211 once installed is stored in the HDD 230, is read into the RAM 210 and is implemented as a network-configuration management process 221 by the CPU 220.

According to the present embodiment, the LAN data, the subnet data, and the routing data are presented as examples of the upper-layer data. However, other upper-layer data can also be used.

According to an embodiment of the present invention, a network configuration map is displayed based on the upper layer specified by a user. As a result, a clear network configuration map that can be easily read by the user is displayed.

Furthermore, according to an embodiment of the present invention, the servers that belong to the same VLAN are placed close to each other. As a result, a clear network configuration map that can be read by the user is displayed.

Moreover, according to an embodiment of the present invention, the servers that belong to the same router are placed close to each other. As a result, a clear network configuration map that can be easily read by the user is displayed.

Furthermore, according to an embodiment of the present invention, the servers are grouped based on the router they belong to. As a result, and the servers that belong to the same router are placed close to each other.

Moreover, according to an embodiment of the present invention, the servers are grouped based on the subnet to which they belong. As a result, a clear network configuration map that can be easily read by the user is displayed.

Furthermore, according to an embodiment of the present invention, the grouping result is reflected in the layout. As a result, a network configuration map based on the grouping result is displayed.

Moreover, according to an embodiment of the present invention, the groups are distinctly displayed. As a result, a clear network configuration map that can be easily read by the user is displayed.

Furthermore, according to an embodiment of the present invention, the plurality of groupings is distinctly displayed so that the groupings can be easily distinguished by the user. As a result, a clear network configuration map that can be easily read by the user is displayed.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program for managing a configuration of a network in which a plurality of network devices including a plurality of servers is connected, wherein
the computer program causes a computer to execute:
receiving an upper layer specification from a user;
grouping the servers based on the received upper layer specification; and
displaying the configuration of the network based on the grouping of the servers.

2. The computer-readable recording medium according to claim 1, wherein
the upper layer specification is a virtual local-area-network specification.

3. The computer-readable recording medium according to claim 1, wherein
the upper layer specification is either one of a single routing specification and a routing specification with a virtual local-area-network specification.

4. The computer-readable recording medium according to claim 3, wherein
when the routing specification is used as the upper layer specification, the grouping includes the servers based on a router that includes a default gateway of each of the servers.

5. The computer-readable recording medium according to claim 1, wherein
the upper layer specification is either one of a single subnet specification and a subnet specification with other upper layer specification.

6. The computer-readable recording medium according to claim 1, wherein
the displaying includes displaying the configuration of the network by determining a location of each of the network device based on the grouping of the servers and a physical-connection data pertaining to a physical connection between the network devices.

7. The computer-readable recording medium according to claim 6, wherein
the computer program further causes the computer to execute receiving a frame specification specifying whether to enclose each group of servers in a frame from the user, and
the displaying includes displaying, when the received frame specification specifies to enclose a group of servers, the group of servers enclosed in a frame.

8. The computer-readable recording medium according to claim 7, wherein
when a plurality of groupings is performed based on a plurality of upper layer specifications at the grouping, the displaying includes displaying a plurality of groups of servers enclosed in frames of different line types.

9. A method of managing a configuration of a network in which a plurality of network devices including a plurality of servers is connected, the method comprising:
receiving an upper layer specification from a user;
grouping the servers based on the received upper layer specification; and
displaying the configuration of the network based on the grouping of the servers.

10. The method according to claim 9, wherein
the upper layer specification is a virtual local-area-network specification.

11. The method according to claim 9, wherein
the upper layer specification is either one of a single routing specification and a routing specification with a virtual local-area-network specification.

12. The method according to claim 9, wherein
the upper layer specification is either one of a single subnet specification and a subnet specification with other upper layer specification.

13. The method according to claim 9, wherein
the displaying includes displaying the configuration of the network by determining a location of each of the network device based on the grouping of the servers and a physical-connection data pertaining to a physical connection between the network devices.

14. The method according to claim 13, further comprising:
receiving a frame specification specifying whether to enclose each group of servers in a frame from the user, wherein
the displaying includes displaying, when the received frame specification specifies to enclose a group of servers, the group of servers enclosed in a frame.

15. A network-configuration management apparatus that manages a configuration of a network in which a plurality of network devices including a plurality of servers is connected, the network-configuration management apparatus comprising:
an upper-layer-specification receiving unit that receives an upper layer specification from a user;
a grouping unit that groups the servers based on the received upper layer specification; and
a configuration display unit that displays the configuration of the network based on the grouping of the servers.

16. The network-configuration management apparatus according to claim 15, wherein
the upper layer specification is a virtual local-area-network specification.

17. The network-configuration management apparatus according to claim 15, wherein
the upper layer specification is either one of a single routing specification and a routing specification with a virtual local-area-network specification.

18. The network-configuration management apparatus according to claim 15, wherein
the upper layer specification is either one of a single subnet specification and a subnet specification with other upper layer specification.

19. The network-configuration management apparatus according to claim 15, wherein
the configuration display unit displays the configuration of the network by determining a location of each of the network device based on the grouping of the servers and a physical-connection data pertaining to a physical connection between the network devices.

20. The network-configuration management apparatus according to claim 19, further comprising:
a frame specification receiving unit that receives a frame specification specifying whether to enclose each group of servers in a frame from the user, wherein
the configuration display unit displays, when the received frame specification specifies to enclose a group of servers, the group of servers enclosed in a frame.
